(19) United States
(12) Patent Application Publication
(10) Pub. No.: US 2022/0290052 A1
(43) Pub. Date: Sep. 15, 2022

(54) PYROLYSIS RESIDUE-DISCHARGE SYSTEM, PYROLYSIS REACTOR ASSEMBLY COMPRISING THE SAME AND CORRESPONDING METHOD

(71) Applicant: 9399-1131 QUÉBEC INC., Saint-Tite (CA)

(72) Inventors: Anthony Goncalves, Quebec (CA); Antoine Langlois, Saint-Tite (CA); Simon Langlois, Saint-Tite (CA)

(21) Appl. No.: 17/691,347

(22) Filed: Mar. 10, 2022

Related U.S. Application Data
(60) Provisional application No. 63/200,490, filed on Mar. 10, 2021.

(51) Int. Cl. C10B 33/00

(52) U.S. Cl. CPC C10B 33/00

(57) ABSTRACT

The present disclosure concerns a pyrolysis residue-discharge system fluid-tightly connectable to a pyrolysis reactor delimiting a fuel-containing cavity and having a discharge opening extending therethrough, the pyrolysis residue-discharge system comprising a residue discharge duct defining a residue discharge passageway having an inlet port and an outlet port; and a reactor-connecting end portion having a through opening, the reactor-connecting end portion being fluid-tightly connectable to the pyrolysis reactor to fluidly connect the through opening of the reactor-connecting end portion with the discharge opening of the pyrolysis reactor, the reactor-connecting end portion being fluid-tightly connectable to the residue discharge duct at the inlet port thereof to provide a fluid communication between the fuel-containing cavity of the pyrolysis reactor and the residue discharge passageway via the discharge opening. It also concerns a corresponding pyrolysis reactor assembly and a pyrolysis residue discharge method.

### PRIOR APPLICATION

The present application claims priority from U.S. provisional patent application No. 63/200,490, filed on Mar. 10, 2021, and entitled “PYROLYSIS SYSTEM AND CORRESPONDING METHOD”, the disclosure of which being hereby incorporated by reference in its entirety.

### TECHNICAL FIELD

The technical field relates to pyrolysis systems, and more particularly to pyrolysis residue-discharge systems and to corresponding methods.

### BACKGROUND

Pyrolysis is commonly used to thermally decompose materials at elevated temperatures in the absence of oxygen. Pyrolysis systems can be used, for instance, to produce coal upon pyrolysis of wood. In general, pyrolysis of organic substances produces gas and liquid products or pyrolysis byproducts, such as, for instance, methyl alcohol, acetic acid, wood tars and/or combustible gas and leaves a solid residue richer in carbon content, such as charcoal. The pyrolysis gas and liquid byproducts can be highly flammable and thus need to be discharged.

The pyrolysis of wood into charcoal produces, amongst others, a solid residue, the charcoal, a combustible gas, and various fractions which condenses including pyroligneous acid, separable by decantation into pyroligneous juice and tars.

In view of the above, there is a need for a pyrolysis system which would be able to overcome or at least minimize some of the above-discussed prior art concerns.

### BRIEF SUMMARY

It is therefore an aim of the present invention to address the above-mentioned issues.

According to a general aspect, there is provided a pyrolysis residue-discharge system fluid-tightly connectable to a pyrolysis reactor at least partially delimiting a fuel-containing cavity and having a discharge opening extending therethrough to provide access to the fuel-containing cavity, the pyrolysis residue-discharge system comprising: a residue discharge duct defining a residue discharge passageway having an inlet port and an outlet port; and a reactor-connecting end portion having a through opening, the reactor-connecting end portion being fluid-tightly connectable to the pyrolysis reactor to fluidly connect the through opening of the reactor-connecting end portion with the discharge opening of the pyrolysis reactor, the reactor-connecting end portion being fluid-tightly connectable to the residue discharge duct at the inlet port thereof or being formed integral with the residue discharge duct and at least partially delimiting the inlet port thereof to provide a fluid communication between the fuel-containing cavity of the pyrolysis reactor and the residue discharge passageway via the discharge opening.

According to another general aspect, there is provided a pyrolysis reactor assembly comprising: a pyrolysis reactor at least partially delimiting a fuel-containing cavity and having a discharge opening extending therethrough to provide access to the fuel-containing cavity; and a pyrolysis residue discharge system comprising a residue discharge duct defining a residue discharge passageway having an inlet port and an outlet port, the residue discharge duct being fluid-tightly connected to the pyrolysis reactor at the inlet port thereof to provide a fluid communication between the fuel-containing cavity of the pyrolysis reactor and the residue discharge passageway via the discharge opening.

According to another general aspect, there is provided a pyrolysis system comprising: a pyrolysis reactor assembly according to the present disclosure, and a pyrolysis oven at least partially delimiting a reactor-receiving cavity and having a drainage opening extending therethrough, the pyrolysis reactor being at least partially contained in the reactor-receiving cavity; wherein the pyrolysis residue-discharge system is fluid-tightly connected to the pyrolysis oven, the residue discharge passageway being fluidly connected with the drainage opening.

According to another general aspect, there is provided a method for discharging pyrolysis residues generated upon pyrolysis of a fuel, the method comprising: providing a pyrolysis reactor at least partially delimiting a fuel-containing cavity and having a discharge opening extending therethrough; feeding the fuel-containing cavity with the fuel; inserting the pyrolysis reactor into a reactor-receiving cavity of a pyrolysis oven, the pyrolysis oven having a drainage opening extending therethrough; providing a pyrolysis byproduct residue discharge system comprising a residue discharge duct defining a residue discharge passageway having an inlet port and an outlet port; fluid-tightly connecting the residue discharge duct to the pyrolysis reactor at the inlet port thereof, with the inlet port being in fluid communication with the discharge opening of the pyrolysis reactor; and fluid-tightly connecting the residue discharge duct to the pyrolysis oven at the outlet port thereof, with the outlet port being in fluid communication with the drainage opening of the pyrolysis oven and opening into an oven exterior; wherein the pyrolysis residues generated in the fuel-containing cavity upon pyrolysis of the fuel are discharged outwardly of the fuel-containing cavity and the reactor-receiving cavity via the residue discharge passageway of the pyrolysis byproduct residue discharge system.

According to another general aspect, there is provided a pyrolysis residue-discharge assembly engageable with a pyrolysis system comprising a pyrolysis reactor having a peripheral wall defining at least partially a fuel-containing cavity and having a discharge opening extending therethrough to provide access to the fuel-containing cavity, the pyrolysis residue-discharge assembly comprising: a residue discharge duct defining a residue discharge passageway having an inlet port and an outlet port; and a container-connecting end portion sealingly engageable with and securable to the peripheral wall of the pyrolysis reactor and to the residue discharge duct at the inlet port thereof to provide a fluid communication between the fuel-containing cavity and the residue discharge passageway via the discharge opening.

According to another general aspect, there is provided a pyrolysis reactor assembly for a pyrolysis system, the pyrolysis reactor assembly comprising: a pyrolysis reactor having a peripheral wall defining at least partially a fuel-containing cavity and having a discharge opening extending therethrough to provide access to the fuel-containing cavity; and a pyrolysis residue discharge assembly comprising: a residue discharge duct defining a residue discharge passageway having an inlet port and an outlet port; and a container-connecting end portion sealingly engaged with and secured to the peripheral wall of the pyrolysis reactor and to the residue discharge duct at the inlet port thereof to provide a fluid communication between the fuel-containing cavity and the residue discharge passageway via the discharge opening.

According to another general aspect, there is provided a method for discharging pyrolysis residues generated upon pyrolysis of a fuel, the method comprising: providing a pyrolysis reactor having a peripheral wall defining at least partially a combustion chamber and having a discharge opening extending therethrough; feeding the combustion chamber with fuel; inserting the pyrolysis reactor into a reactor-receiving cavity of a pyrolysis oven, the pyrolysis oven having a wall portion at least partially delimiting the reactor-receiving cavity and comprising a drainage opening extending therethrough; providing a pyrolysis byproduct residue discharge assembly comprising a byproduct residue discharge duct defining a residue discharge passageway having an inlet port and an outlet port, and a container-connecting end portion; and sealingly engaging the container-connecting end portion with both the peripheral wall of the pyrolysis reactor and the byproduct residue discharge duct at the inlet port thereof, with the byproduct residue discharge duct extending through the drainage opening and the outlet port being located in an oven exterior, wherein the pyrolysis residues generated in the combustion chamber upon pyrolysis of the fuel are discharged outwardly of the combustion chamber and the oven via the pyrolysis byproduct residue discharge assembly.

### BRIEF DESCRIPTION OF THE DRAWINGS

FIG. 1 is a side perspective view of a pyrolysis assembly comprising a heat-producing unit, a byproduct residue-collecting unit, a pyrolysis system in accordance with an embodiment of the present disclosure and a byproduct residue discharge line fluidly connecting the pyrolysis system to the byproduct residue-collecting unit;

FIG. 2 is top perspective view of the pyrolysis assembly of FIG. 1;

FIG. 3 is a top perspective view of the pyrolysis system of FIG. 1, the pyrolysis system comprising a pyrolysis oven and a pyrolysis reactor at least partially contained in a reactor-receiving cavity of the pyrolysis oven, the pyrolysis system further comprising a pyrolysis residue-discharge system fluidly connecting a fuel-containing cavity of the pyrolysis reactor with an oven exterior of the pyrolysis system;

FIG. 4 is a cross-sectional view of the pyrolysis system of FIG. 3;

FIG. 5 is an exploded view of a portion of the pyrolysis residue-discharge system of FIG. 3, the pyrolysis residue-discharge system comprising a residue-recovering end portion, a residue discharge duct and a reactor-connecting end portion;

FIG. 6 is a cross-sectional view of the pyrolysis reactor of FIG. 3, the residue-recovering end portion and the residue discharge duct of the pyrolysis residue-discharge system being removed; and

FIG. 7 is a block diagram representing the different steps of a method for discharging pyrolysis byproduct residues generated upon pyrolysis of a fuel in accordance with an embodiment.

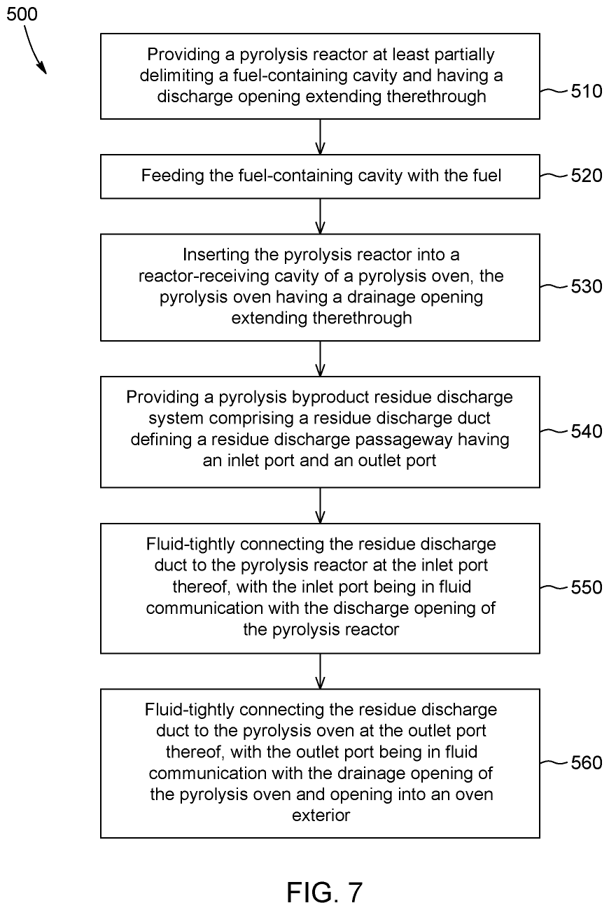

### DETAILED DESCRIPTION

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional and are given for exemplification purposes only. Moreover, it will be appreciated that positional descriptions such as “above”, “below”, “forward”, “rearward”, “left”, “right” and the like should, unless otherwise indicated, be taken in the context of the figures only and should not be considered limiting. Moreover, the figures are meant to be illustrative of certain characteristics of the pyrolysis assembly and its components and are not necessarily to scale.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

In the following description, an embodiment is an example or implementation. The various appearances of “one embodiment”, “an embodiment” or “some embodiments” do not necessarily all refer to the same embodiments. Although various features may be described in the context of a single embodiment, the features may also be provided separately or in any suitable combination. Conversely, although the invention may be described herein in the context of separate embodiments for clarity, it may also be implemented in a single embodiment. Reference in the specification to “some embodiments”, “an embodiment”, “one embodiment” or “other embodiments” means that a particular feature, structure, or characteristic described in connection with the embodiments is included in at least some embodiments, but not necessarily all embodiments.

It is to be understood that the phraseology and terminology employed herein is not to be construed as limiting and are for descriptive purpose only. The principles and uses of the teachings of the present disclosure may be better understood with reference to the accompanying description, figures and examples. It is to be understood that the details set forth herein do not construe a limitation to an application of the disclosure.

Furthermore, it is to be understood that the disclosure can be carried out or practiced in various ways and that the disclosure can be implemented in embodiments other than the ones outlined in the description above. It is to be understood that the terms “including”, “comprising”, and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not to be construed as a single element. It is to be understood that where the specification states that a component, feature, structure, or characteristic “may”, “might”, “can” or “could” be included, that particular component, feature, structure, or characteristic is not required to be included.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined. It will be appreciated that the methods described herein may be performed in the described order, or in any suitable order.

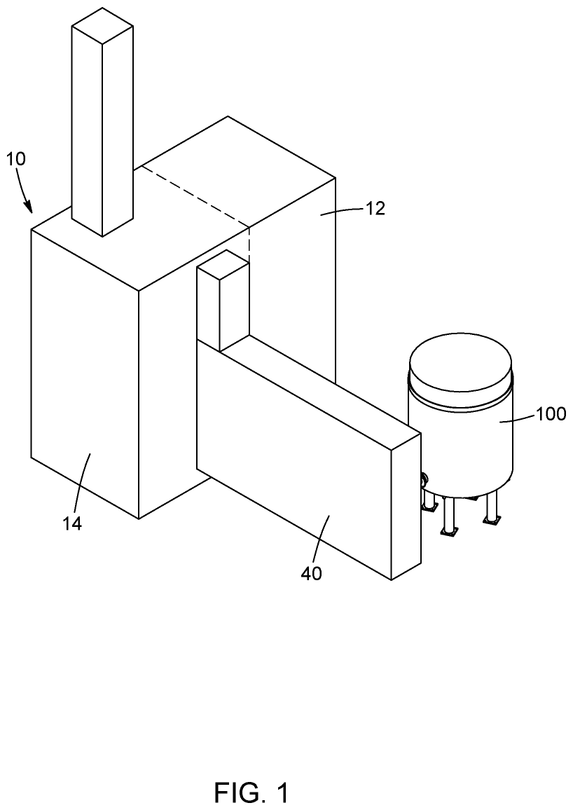

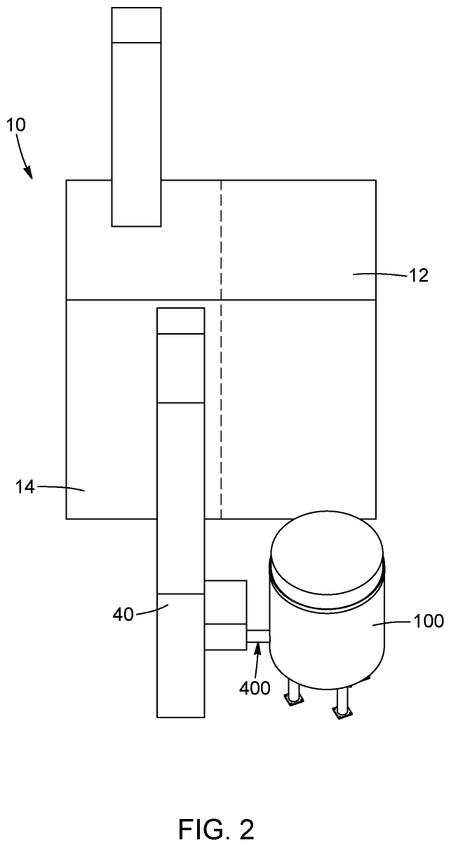

Referring now to the drawings, and more particularly to FIGS. 1 and 2, there is shown a pyrolysis assembly 10 comprising a heat-producing unit 12 and a pyrolysis system 100 in accordance with an embodiment of the present disclosure.

In the embodiment shown, the pyrolysis assembly 10 is for production of coal or charcoal by pyrolysis of wood, but the pyrolysis assembly 10 could be configured to decompose any other organic materials—or fuel—at elevated temperatures in the absence of oxygen. As mentioned above, the pyrolysis of wood into charcoal produces, amongst others, a solid product, the charcoal itself, and a plurality of byproducts, such as for instance a combustible gas, and various fractions which condense including pyroligneous acid, separable by decantation into pyroligneous juice and tars. The various fractions, in liquid or solid states, excluding the charcoal, are referred to as byproduct residues.

In the embodiment shown, the pyrolysis assembly 10 might comprise a high temperature fluid circulation network (not represented) fluidly connecting the heat-producing unit 12 and the pyrolysis system 100 and providing a high temperature heat transfer fluid (for instance heated air) having a temperature higher than about 500° C., for instance higher than about 700° C., for instance higher than about 800° C., to the pyrolysis system 100. The pyrolysis assembly 10 further comprises a low temperature fluid circulation network (not represented) fluidly connecting the pyrolysis system 100 to the heat-producing unit 12 and discharging a low temperature heat transfer fluid from the pyrolysis system 100 toward the heat-producing unit 12. The high temperature fluid circulation network and the low temperature fluid circulation network might be in fluid communication with each other, and the same heat transfer fluid might circulate in both the high and low temperature fluid circulation networks with the heat transfer fluid being at a higher temperature in the high temperature fluid circulation network and at a lower temperature in the low temperature fluid circulation network.

As represented in FIGS. 1 and 2, the pyrolysis assembly 10 further comprises a byproduct residue-collecting unit 14 and a byproduct residue discharge network 40 fluidly connecting the pyrolysis system 100 to the byproduct residue-collecting unit 14 so as to collect pyrolysis byproduct residues generated upon pyrolysis of the fuel in the pyrolysis system 100.

In the embodiment shown, the byproduct residue-collecting unit 14 might be in fluid communication with the heat-producing unit 12 so that the pyrolysis byproduct residues of the pyrolysis system 100 are used to heat the heat transfer fluid circulating in the pyrolysis assembly 10.

It is appreciated that the shape, the configuration, and the location of heat-producing unit, the high and low temperature circulation lines, the residue discharge line and the residue-collecting unit can vary from the embodiment shown. The pyrolysis assembly might comprise a plurality of pyrolysis systems for instance in fluid communication with each other via at least one of the high and low temperature fluid circulation networks and/or with the residue discharge line.

### Pyrolysis System

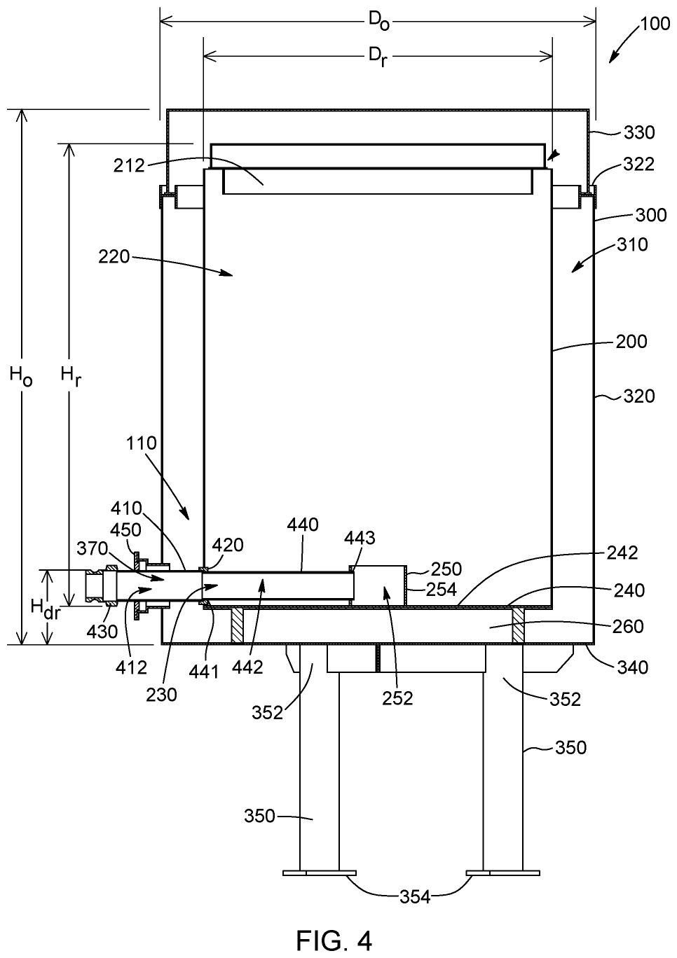

As detailed below and as best shown in FIG. 4, the pyrolysis system 100 comprises a fuel container 200 (or pyrolysis reactor) to contain a fuel, such as a solid fuel (for instance wood). The pyrolysis reactor 200 is contained—or enclosed or received or arranged—in a reactor-receiving cavity 310 of a pyrolysis oven 300 in which the heat transfer fluid circulates so as to enable thermal decomposition of the fuel contained in the pyrolysis reactor 200 at elevated temperatures in the absence of oxygen. In other words, the pyrolysis system 100 comprises the fuel container 200 and the pyrolysis oven 300, the pyrolysis oven 300 at least partially delimiting the reactor-receiving cavity and containing (i.e., enclosing) the pyrolysis reactor 200 and being configured to thermally decompose fuel contained within the fuel container. The reactor-receiving cavity 310 of the oven 300 is supplied in heat transfer fluid through the above-mentioned high temperature fluid circulation network and the heat transfer fluid is withdrawn from the reactor-receiving cavity 310 through the above-mentioned low temperature fluid circulation network. Thus, in the embodiment shown, the heat transfer fluid circulates in a closed loop between the heat-producing unit 12, wherein the heat transfer fluid is heated, the high temperature fluid circulation network, in which the heat transfer fluid is conveyed towards the reactor-receiving cavity 310 of the pyrolysis oven 300, in the reactor-receiving cavity 310 of the pyrolysis oven 300, wherein it releases heat to enable thermal decomposition of the fuel contained in the pyrolysis reactor 200 contained within the reactor-receiving cavity of the oven 300, and, then, the heat transfer fluid is returned to the heat-producing unit 12 through the low temperature fluid circulation network, in order to be reheated.

As detailed above, the pyrolysis oven 300 is in fluid communication with the heat-producing unit 12 via the above-mentioned high temperature fluid circulation network for the high temperature heat transfer fluid to be introduced (or fed) into the reactor-receiving cavity of the pyrolysis oven 300 and circulate at least partially around the pyrolysis reactor 200 contained in the reactor-receiving cavity. A heat transfer then occurs between the circulating heat transfer fluid and the fuel contained in the fuel container 200 (or pyrolysis reactor 200) to thermally decompose the fuel contained therein. Due to the heat transfer, a temperature of the circulating heat transfer fluid decreases and the low temperature heat transfer fluid removed from the reactor-receiving cavity of the pyrolysis oven 300 is discharged towards the heat-producing unit 12 via the low temperature fluid circulation network.

Upon decomposition of the fuel contained in the fuel-containing cavity 220 of the pyrolysis reactor 200, gaseous and/or liquid pyrolysis byproduct residues (for instance methyl alcohol, acetic acid, wood tars and/or combustible gas) can be generated that can be highly flammable and thus need to be safely (i.e., without being in contact with the heat transfer fluid circulating in the reactor-receiving cavity) discharged out of the pyrolysis system 100 (i.e., out of the fuel-containing cavity and of the reactor-receiving cavity).

Pyrolysis Oven

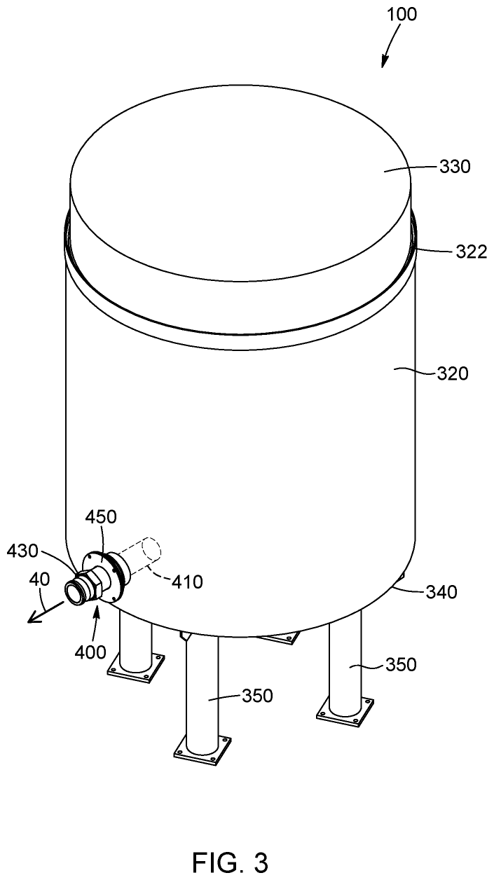

As best shown in FIGS. 3 and 4, the pyrolysis oven 300 comprises a wall portion or peripheral wall 320 at least partially delimiting the reactor-receiving cavity 310. In the embodiment shown, the pyrolysis oven 300 has a substantially cylindrical shape and comprises an oven lid 330 mounted—for instance in a removable manner and fluidtight manner—to an upper edge 322 of the peripheral wall 320 so as to configure the pyrolysis oven 300 into an open configuration, to provide access to the reactor-receiving cavity 310 so as to introduce the pyrolysis reactor 200 therein, or into a closed configuration, as represented in FIGS. 3 and 4, wherein the oven lid 330 is secured (for instance mounted) to the upper edge of the peripheral wall 320 in a substantially fluid-tight manner.

In the embodiment shown, the pyrolysis oven 300 further comprises a bottom wall 340 (for instance substantially disk-shaped) delimiting the reactor-receiving cavity 310 with the peripheral wall 320 and the oven lid 330. For instance, the pyrolysis oven 300 further comprises oven supports 350 having a bottom-mounting end portion 352 mounted to an outer face (with respect to the reactor-receiving cavity) of the bottom wall 340 and an opposed ground-contacting end portion 354, so as to support the pyrolysis oven 300 on a ground surface, for instance spaced-apart therefrom.

The pyrolysis oven 300 might comprise a thermal fluid inlet port (or heat transfer fluid inlet port—not represented), for instance formed in the peripheral wall 320, and a thermal fluid outlet port (or heat transfer fluid outlet port—not represented), for instance also formed in the peripheral wall 320. The thermal fluid inlet port and the thermal fluid outlet port could be fluidly connected respectively to the high and low temperature fluid circulation networks to allow circulation of the thermal fluid—or heat transfer fluid—in the reactor-receiving cavity 310.

In the embodiment shown, the pyrolysis oven 300 has a drainage opening 370 formed therethrough, for instance formed in the peripheral wall 320, for instance in a lower portion thereof and has for instance a substantially circular shape. As best shown in FIG. 4, the drainage opening 370 extends for instance through the peripheral wall 320, slightly above the bottom wall 340, and provides a fluid communication between the reactor-receiving cavity 310 and an oven exterior. For instance, a height Hdr of the drainage opening 370, considered from the bottom wall 340 of the pyrolysis oven 300, is smaller than about 50%, for instance smaller than about 40%, for instance smaller than about 25%, for instance smaller than about 10% of a height Ho of the pyrolysis oven 300.

It is appreciated that the shape and the configuration of the pyrolysis oven 300, as well as the shape, the configuration and the relative arrangement of the thermal fluid inlet port, the thermal fluid outlet port and the drainage opening can vary from the embodiment shown.

Pyrolysis Reactor Assembly

In the embodiment shown, the pyrolysis system 100 comprises a pyrolysis reactor assembly 110 comprising the above-mentioned pyrolysis reactor 200 (or fuel container 200) and a pyrolysis byproduct residue discharge system 400 (or pyrolysis residue discharge system 400).
Pyrolysis Reactor

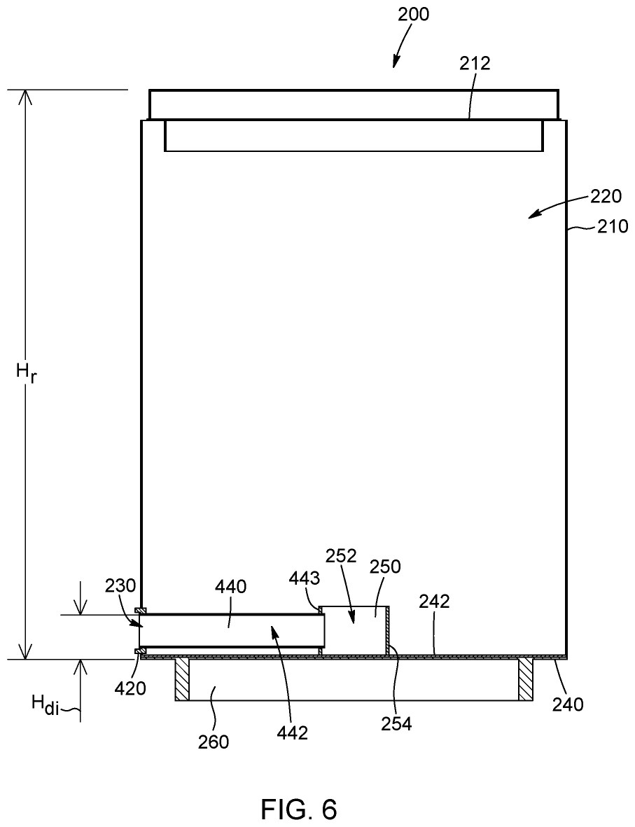

In the embodiment shown, as represented for instance in FIG. 6, the pyrolysis reactor 200 at least partially delimits a fuel-containing cavity 220 (for instance a wood-containing cavity 220 or combustion chamber 220 or pyrolysis chamber 220) and has a discharge opening 230 extending therethrough to provide access to the fuel-containing cavity 220. In the embodiment shown, the pyrolysis reactor 200 has a peripheral wall 210 at least partially delimiting the fuel-containing cavity 220. For instance, the peripheral wall 210 of the pyrolysis reactor 200 has a substantially cylindrical shape and has a diameter Dr and a height Hr smaller than respectively a diameter Do and the height Ho of the pyrolysis oven 300, for the pyrolysis reactor 200 to be contained in the reactor-receiving cavity 310 of the pyrolysis oven 300 when the oven lid 330 is configured in the closed configuration. For instance, at least one of the diameter Dr and the height Hr of the pyrolysis reactor 200 is smaller than about 95%, for instance smaller than about 90%, for instance smaller than about 80%, for instance smaller than about 70%, of the corresponding one of the diameter Do and the height Ho of the pyrolysis oven 300.

The pyrolysis reactor 200 further comprises a reactor lid 212 for instance removably mountable in a fluid-tight manner to the peripheral wall 210 (at an upper portion thereof) to provide access to the fuel-containing cavity 220, to provide the fuel-containing cavity 220 with fuel and to collect a carbonized material, for instance the charcoal, formed upon pyrolysis of the fuel.

As best shown in FIG. 4, the pyrolysis reactor 200 comprises a discharge opening 230 extending through the pyrolysis reactor 200, for instance through the peripheral wall 210 in the embodiment shown, and providing access to the fuel-containing cavity 220. For instance, the discharge opening 230 is substantially circular and is substantially in register with the drainage opening 370 of the pyrolysis oven 300 when the pyrolysis reactor 200 is in the reactor-receiving cavity 310 of the pyrolysis oven 300.

In the embodiment shown, the pyrolysis reactor 200 further comprises a bottom wall 240, the peripheral wall 210 extending upwardly from the bottom wall 240 and at least partially delimiting therewith the fuel-containing cavity 220. For instance, a height Hdi of the discharge opening 230, considered from the bottom wall 240 of the pyrolysis reactor 200, is smaller than about 50%, for instance smaller than about 40%, for instance smaller than about 25%, for instance smaller than about 10% of the height Hr of the pyrolysis reactor 200.

In the embodiment shown, the pyrolysis reactor 200 further comprises a byproduct residue-collecting member 250 arranged in the fuel-containing cavity 220 and extending upwardly from an inner surface 242 (with respect the fuel-containing cavity 220) of the bottom wall 240, for instance substantially centrally thereof.

In the embodiment shown, the byproduct residue-collecting member 250 is substantially cylindrical and defines a byproduct residue-collecting cavity 252. The byproduct residue-collecting member 250 comprises a peripheral wall 254 at least partially delimiting the byproduct residue-collecting cavity 252. The byproduct residue-collecting cavity 252 opens into (or is in fluid communication with) the fuel-containing cavity 220, at an upper portion of the peripheral wall 254. A lower portion of the peripheral wall 254 is secured to or formed integral with the inner surface 242 of the bottom wall 240, so that the bottom wall 240 of the pyrolysis reactor 200 at least partially delimits the byproduct residue-collecting cavity 252.

It is thus understood that pyrolysis byproduct residues generated upon pyrolysis of the fuel contained in the fuel-containing cavity 220 (or combustion chamber) of the pyrolysis reactor 200 are collectable in the byproduct residue-collecting cavity 252 located in a lower portion of the fuel-containing cavity 220, substantially centrally thereof.

In the embodiment shown, the pyrolysis reactor 200 further comprises reactor-supporting member 260 (for instance comprising a substantially cylindrical body) mounted to an outer surface of the bottom wall 240 and abuttable against the bottom wall 340 (against the inner surface thereof) of the pyrolysis oven 300 when the pyrolysis reactor 200 is contained in the reactor-receiving cavity 310 to space apart from each other the bottom wall 240 of the pyrolysis reactor 200 and the bottom wall 340 of the pyrolysis oven 300 and to substantially vertically align, considered along the heights of the pyrolysis reactor 200 and the pyrolysis oven 300, the discharge opening 230 formed in in the peripheral wall of the pyrolysis reactor 200 with the drainage opening 370 formed in the peripheral wall of the pyrolysis oven (i.e., for the discharge opening 230 and the drainage opening 370 to be substantially aligned with each other and, in some implementations, substantially in register with each other).

It is appreciated that the shape and the configuration of the pyrolysis reactor, as well as the shape, the configuration and the relative arrangement of the discharge opening and the byproduct residue-collecting member thereof, can vary from the embodiment shown. For instance, the discharge opening could be formed in other locations of the peripheral wall and/or could have other shapes. It could also be conceived a pyrolysis container with a plurality of discharge openings formed in the peripheral wall thereof or without the byproduct residue-collecting member therein.
Pyrolysis Byproduct Residue Discharge System

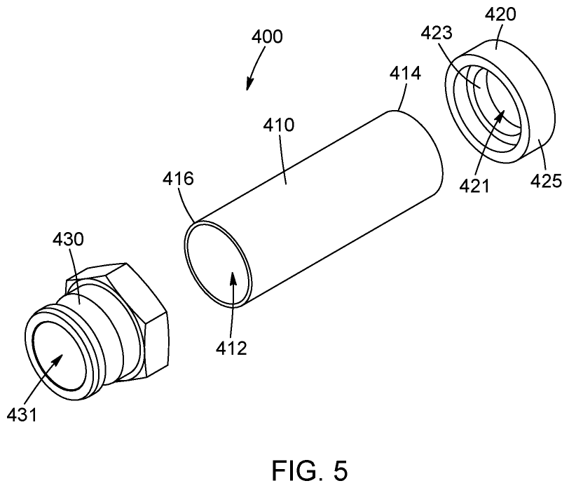

As best shown in FIGS. 3 to 6, the pyrolysis byproduct residue discharge system 400 (or pyrolysis residue discharge system 400) of the pyrolysis reactor assembly 110 comprises a byproduct residue discharge duct 410 defining a byproduct residue discharge passageway 412 having an inlet port 414 and an outlet port 416. In the embodiment shown, the byproduct residue discharge duct 410 is substantially tubular, for instance substantially cylindrical.

The pyrolysis byproduct residue discharge assembly 400 further comprises a container-connecting end portion 420 (or reactor-connecting end portion 420) having a through opening 421, the reactor-connecting end portion 420 being sealingly engageable with (i.e., fluid-tightly connectable to) (for instance securable and/connectable to in a fluid-tight manner) the pyrolysis reactor 200 (for instance to the peripheral wall 210 of the pyrolysis reactor 200) to fluidly connect the through opening 421 of the reactor-connecting end portion 420 with the discharge opening 230 of the pyrolysis reactor 200. In the embodiment shown, the reactor-connecting end portion 420 is sealingly engageable with (i.e., fluid-tightly connectable to) the residue discharge duct 410 at the inlet port 414 thereof or is formed integral with the residue discharge duct 410 and at least partially delimits the inlet port 414 thereof to provide a fluid communication between the fuel-containing cavity 220 (or combustion chamber) and the byproduct residue discharge passageway 412 via the discharge opening 230 formed in the peripheral wall 210 of the pyrolysis reactor 200.

For instance, the container-connecting end portion 420 is fluid-tightly securable to the pyrolysis reactor 200, for instance in a removable manner, for instance to a peripheral edge surrounding the discharge opening of the pyrolysis reactor 200. The container-connecting end portion 420 could also be fixedly fluid-tightly mounted to the pyrolysis reactor 200, for instance to the peripheral wall thereof. The container-connecting end portion 420 could also be at least partially formed integral with a portion of the peripheral wall. In another embodiment, the container-connecting end portion 420 (or reactor-connecting end portion 420) comprises a threaded portion engageable with a corresponding threaded portion located at the peripheral edge surrounding the discharge opening 230 formed in the pyrolysis reactor 200, for instance in the peripheral wall 210 thereof, for the container-connecting end portion 420 to be removably fluid-tightly secured to the pyrolysis reactor 200.

In other words, the container-connecting end portion 420 might comprise a duct-engaging member, for instance mounted to or formed integral with an inner surface 423 at least partially delimiting the through opening 421 to fluid-tightly connect or engage the container-connecting end portion 420 to the residue discharge duct at the inlet port thereof, and a container-engaging member, for instance mounted to or formed integral with an outer surface 425 of the container-connecting end portion 420, to sealingly engage (i.e., fluid-tightly connect) the container-connecting end portion 420 to the pyrolysis reactor 200. It is understood that when the container-connecting end portion 420 is at least partially formed integral with the pyrolysis reactor, it might comprise only the duct-engaging member. Similarly, when the container-connecting end portion 420 is at least partially formed integral with the residue discharge duct and at least partially delimits the inlet port thereof, it might comprise only the container-engaging member.

For instance, the byproduct residue discharge duct 410 is removably fluid-tightly mountable to the pyrolysis reactor 200 via the inlet port 414 thereof being sealingly engageable with (i.e., fluid-tightly connectable to) (for instance removably fluid-tightly securable to) the reactor-connecting end portion 420.

For instance, the pyrolysis residue-discharge system 400 comprises a quick-connect system shaped and dimensioned to allow a quick and easy fluid-tight connection of the residue discharge duct to the pyrolysis reactor via the reactor-connecting end portion. For instance, the reactor-connecting end portion comprises a sealing member to provide a sealed (i.e., fluid-tight) connection of the pyrolysis byproduct residue-discharge system with the pyrolysis reactor.

The pyrolysis byproduct residue discharge assembly 400 further comprises a byproduct residue-recovering end portion 430 having a through opening 431, the byproduct residue-recovering end portion 430 being opposed to the container-connecting end portion 420 (or reactor-connecting end portion 420). The byproduct residue-recovering end portion 430 is sealingly engageable with (i.e., fluid-tightly connectable to) (for instance securable and/or connectable to in a fluid-tight manner) the byproduct residue discharge duct 410 at the outlet port 416 thereof or formed integral with the residue discharge duct and at least partially delimits the outlet port 416 thereof to fluidly connect the through opening 431 of the byproduct residue-recovering end portion 430 with the discharge passageway of the residue discharge duct 410.

For instance, the pyrolysis residue-discharge assembly 400 might further comprise a quick-connect system shaped and dimensioned to allow a quick and easy fluid-tight connection of the residue discharge duct 410 to a byproduct residue discharge line via the byproduct residue-recovering end portion. For instance, the discharge line of the pyrolysis assembly 10 might be part of the byproduct residue discharge network 40, at a reactor-connecting portion thereof. In other words, the byproduct residue discharge line 40 is in fluid communication with the fuel-containing cavity 220 (or combustion chamber 220, or at least with the residue-collecting cavity 252 thereof) of the pyrolysis reactor 200 via the pyrolysis byproduct residue-discharge assembly 400 (via the byproduct residue discharge passageway 412 thereof).

In the embodiment shown, at least one of the container-connecting end portion 420 and the byproduct residue-recovering end portion 430 comprises a sealing member (for instance an O-ring or any other suitable sealing piece) to provide a sealed (i.e., fluidtight) connection of the pyrolysis byproduct residue-discharge assembly 400 respectively with the pyrolysis reactor 200 and the byproduct residue discharge line of the byproduct residue discharge network 40.

In the embodiment shown, as represented in FIG. 4, the pyrolysis byproduct residue-discharge assembly 400 further comprises a byproduct residue-collecting duct 440 arranged at least partially in the fuel-containing cavity 220, for instance in the lower portion thereof, for instance proximate the bottom wall thereof. In the embodiment shown, the byproduct residue-collecting duct 440 is fluid-tightly engageable with (i.e., fluid-tightly connectable to) the container-connecting end portion 420 at a first end portion 441 thereof and opens into the fuel-containing cavity 220 of the pyrolysis reactor 200 (for instance opens into the byproduct residue-collecting cavity 252 of the above-mentioned byproduct residue-collecting member 250) at a second end portion 443 thereof.

The second end portion 443 of the byproduct residue-collecting duct 440 could be arranged anywhere else in the combustion chamber 220. In other words, the byproduct residue-collecting duct 440 defines a byproduct residue-collecting channel 442 having an inlet port and an outlet port, the byproduct residue-collecting channel 442 being in fluid communication with the combustion chamber 220 (for instance with the byproduct residue-collecting cavity 252) via the inlet port and being in fluid communication with the byproduct residue discharge passageway 412 via the outlet port to direct pyrolysis byproduct residues collected in the combustion chamber 220 (for instance collected in the byproduct residue-collecting cavity 252) towards the byproduct residue discharge network 40. In yet other words, the container-connecting end portion 420 sealingly (i.e., fluid-tightly) connects the byproduct residue discharge duct 410 and the byproduct residue-collecting duct 440. In other words, the container-connecting end portion 420 forms a fluid-tight interface between the byproduct residue-collecting duct 440, the peripheral edge at least partially delimiting the discharge opening formed in the pyrolysis reactor and the byproduct residue discharge duct 410.

When in use, as represented in FIG. 4, the pyrolysis byproduct residue-discharge assembly 400 (at least a portion of the byproduct residue discharge duct 410 thereof) extends in a thermal fluid-circulating portion of the reactor-receiving cavity 310 of the pyrolysis oven 300 surrounding the pyrolysis reactor 200 and provides a fluid-tight separation between the pyrolysis byproduct residues circulating in the byproduct residue-discharge passageway 412 and the thermal fluid circulating in the thermal fluid-circulating portion of the reactor-receiving cavity 310 surrounding the pyrolysis reactor 200. In other words, the pyrolysis byproduct residue-discharge assembly 400 forms a byproduct residue-circulation line extending between the combustion chamber and an oven exterior, the byproduct residue-circulation line forming a fluid-tight housing in the reactor-receiving cavity of the pyrolysis oven 300. For instance, the pyrolysis residue-discharge system 400 is sealingly (i.e., fluid-tightly) securable to a peripheral edge surrounding the drainage opening 370 formed in the pyrolysis oven 300. For instance, the pyrolysis residue-discharge system 400 comprises an oven-connecting member 450 having a through-opening 451 shaped and dimensioned to receive in a fluid-tight manner a portion of the residue discharge duct 410, the oven-connecting member 450 being fluid-tightly securable to the pyrolysis oven 300, the drainage opening 370 being in fluid communication with the through opening 451 of the oven-connecting member 450. In other words, the oven-connecting member 450 forms a sealing member around the byproduct residue discharge duct 410 to engage in a fluid tight manner with the peripheral wall 320 of the pyrolysis oven 300.

It is appreciated that the shape, the configuration, and the location of the pyrolysis byproduct residue-discharge assembly and the different components thereof can vary from the embodiment shown. For instance, it could be conceived a pyrolysis byproduct residue-discharge system that would be in fluid communication with the fuel-containing cavity (or combustion chamber) of the pyrolysis reactor directly via the container-connecting end portion (i.e. a pyrolysis byproduct residue-discharge assembly without the byproduct residue-collecting duct). It could also be conceived a pyrolysis reactor assembly that would comprise more than one pyrolysis byproduct residue-discharge systems providing a fluid communication between the combustion chamber of the pyrolysis rector and the residue discharge line. It could also be conceived a residue discharge duct that would comprise a plurality of duct members fluid-tightly connected to each other and at least partially delimiting together the residue discharge passageway.

### Method for Discharging Pyrolysis Byproduct Residues

According to another aspect of the disclosure, there is provided a method 500 for discharging pyrolysis byproduct residues generated upon pyrolysis of a fuel (for instant wood).

The method 500 according to embodiments of the present disclosure may be carried out with a pyrolysis system 100 as those described above.

In the embodiment shown, the method 500 comprises a step 510 of providing a pyrolysis reactor 200 (or fuel container 200) at least partially delimiting a fuel-containing cavity 220 (or combustion chamber 220) (for instance at least partially delimited by a peripheral wall 210), the pyrolysis reactor 500 having a discharge opening 230 extending therethrough (for instance extending through the peripheral wall 210).

The method 500 further comprises a step 520 of charging the fuel into the fuel-containing cavity and a step 530 of inserting the pyrolysis reactor 200 into a reactor-receiving cavity 310 of a pyrolysis oven 300, wherein the pyrolysis oven 300 has a drainage opening 370 extending therethrough. For instance, the reactor-receiving cavity is at least partially delimited by a wall portion or peripheral wall of the pyrolysis oven, the drainage opening extending through the peripheral wall of the pyrolysis oven.

The method 500 further comprises a step 540 of providing a pyrolysis byproduct residue discharge assembly 400 comprising a byproduct residue discharge duct 410 defining a byproduct residue discharge passageway 412 having an inlet port 414 and an outlet port 416; a step 550 of sealingly engaging (i.e., fluid-tightly connecting) the residue discharge duct with the pyrolysis reactor at the inlet port thereof, the inlet port being in fluid communication with the discharge opening of the pyrolysis reactor; and a step 560 of sealingly engaging (i.e., fluid-tightly connecting) the residue discharge duct with the pyrolysis oven at the outlet port thereof, with the outlet port being in fluid communication with the drainage opening of the pyrolysis oven and opening into an oven exterior. It is thus understood that the pyrolysis residues generated in the fuel-containing cavity upon pyrolysis of the fuel are discharged outwardly of the fuel-containing cavity and the reactor-receiving cavity via the residue discharge passageway of the pyrolysis byproduct residue discharge system.

For instance, the method further comprises sealingly engaging (i.e., fluid-tightly connecting) a container-connecting end portion 420 of the pyrolysis byproduct residue discharge system with the pyrolysis reactor 200 (for instance with the peripheral wall 210 thereof) and sealingly engaging (i.e., fluid-tightly connecting) the container-connecting end portion 420 with the byproduct residue discharge duct 410 at the inlet port 414 thereof. The container-connecting end portion 420 thus forms a fluid-circulating interface between the discharge opening of the pyrolysis reactor and the residue discharge passageway of the residue discharge duct, while ensuring that an entirety of the pyrolysis residues generated in the fuel-containing cavity upon pyrolysis of the fuel are directed towards the residue discharge passageway of the residue discharge duct. For instance, the byproduct residue discharge duct 410 extends through the drainage opening 370 or is sealingly engaged with (i.e., fluid-tightly connected to) a portion of the pyrolysis oven in which the drainage opening 370 is formed and the outlet port 416 is located in or opens into an oven exterior, wherein the pyrolysis byproduct residues generated in the fuel-containing cavity 220 (or combustion chamber 220) upon pyrolysis of the fuel therein is discharged towards the oven exterior. For instance, the byproduct residue discharge duct 410 is sealed to (i.e., fluid-tightly connected to) the peripheral wall of the pyrolysis oven about the drainage opening 370. In the embodiment shown, an O-ring or any other suitable sealing member, such as the above-described oven-connecting member 450 of the pyrolysis residue-discharge system is provided around the byproduct residue discharge duct 410 and might be slidable along the byproduct residue discharge duct 410 to engage with the peripheral wall 320 of the pyrolysis oven 300. In the embodiment shown, once the sealing member is engaged with the peripheral wall 320 of the pyrolysis oven 300 (for instance with an outer surface of the peripheral wall), the sealing member might be secured (for instance welded, glued or permanently secured by any other suitable process) to the peripheral wall 320 of the pyrolysis oven 300.

It is understood that the step of sealingly engaging the residue discharge duct with the pyrolysis reactor at the inlet port thereof, and more particularly with the peripheral wall 210 of the reactor 200, can be carried out before the step of inserting the pyrolysis reactor into the reactor-receiving cavity of the pyrolysis oven. For instance, the container-connecting end portion 420 is engaged with the peripheral wall 210 of the pyrolysis reactor 200 prior to the step 520 of charging the fuel into the fuel-containing cavity. Once the fuel is charged and the pyrolysis reactor is inserted into the reactor-receiving cavity of the pyrolysis oven, the byproduct residue discharge duct could be introduced into the drainage opening of the pyrolysis oven and the inlet port of the byproduct residue discharge duct could be sealingly engaged with (i.e., fluid-tightly connected to) the pyrolysis reactor via the container-connecting end portion.

The discharge of the pyrolysis byproduct residues formed in the combustion chamber of the pyrolysis reactor via a discharge opening formed in the peripheral wall of the pyrolysis reactor increases the efficiency of the residue discharge and limits the risk of an uncontrolled combustion of the pyrolysis byproduct residues. For instance, the method further comprises sealingly engaging (i.e., fluid-tightly connecting) to a residue discharge line a byproduct residue-recovering end portion of the pyrolysis byproduct residue discharge system, the byproduct residue-recovering end portion being sealingly engaged with (i.e., fluid-tightly connected to) the residue discharge duct at the outlet port thereof or being formed integral with the residue discharge duct and at least partially delimiting the outlet port thereof.

In the present description, it should be understood that the definition of a sealed engagement between two components is meant to designate any type of fluid-tight mechanical seal configured to join said two components together by preventing leakage outside therefrom. In the present disclosure, it is thus understood that the discharge of the pyrolysis byproduct residues formed in the combustion chamber of the pyrolysis reactor via the discharge opening into the residue discharge passageway of the residue discharge duct, and the discharge of the pyrolysis byproduct residues circulating in the residue discharge passageway outwardly from the pyrolysis oven is substantially prevented from leaking, for instance, into the reactor-receiving cavity of the pyrolysis oven. It is thus understood that sealingly engaging two components refers to the providing of a fluidtight connection between said two components.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited by the scope of the appended claims.

1. A pyrolysis residue-discharge system fluid-tightly connectable to a pyrolysis reactor at least partially delimiting a fuel-containing cavity and having a discharge opening extending therethrough to provide access to the fuel-containing cavity, the pyrolysis residue-discharge system comprising:
a residue discharge duct defining a residue discharge passageway having an inlet port and an outlet port; and
a reactor-connecting end portion having a through opening, the reactor-connecting end portion being fluid-tightly connectable to the pyrolysis reactor to fluidly connect the through opening of the reactor-connecting end portion with the discharge opening of the pyrolysis reactor, the reactor-connecting end portion being fluid-tightly connectable to the residue discharge duct at the inlet port thereof or being formed integral with the residue discharge duct and at least partially delimiting the inlet port thereof to provide a fluid communication between the fuel-containing cavity of the pyrolysis reactor and the residue discharge passageway via the discharge opening.

2. The pyrolysis residue-discharge system according to claim 1, wherein the reactor-connecting end portion is removably fluid-tightly securable to a peripheral edge surrounding the discharge opening of the pyrolysis reactor.

3. The pyrolysis residue-discharge system according to claim 1, wherein the container-connecting end portion is removably fluid-tightly securable to the residue discharge duct at the inlet port thereof.

4. The pyrolysis residue-discharge system according to claim 1, further comprising a byproduct residue-recovering end portion having a through opening, the byproduct residue-recovering end portion being opposed to the reactor-connecting end portion and being fluid-tightly connectable to the residue discharge duct at the outlet port thereof or being formed integral with the residue discharge duct and at least partially delimiting the outlet port thereof to fluidly connect the through opening of the byproduct residue-recovering end portion with the discharge passageway of the residue discharge duct.

5. The pyrolysis residue-discharge system according to claim 4, wherein the byproduct residue-recovering end portion is fluid-tightly connectable to a byproduct residue discharge line.

6. The pyrolysis residue-discharge system according to claim 5, further comprising at least one quick-connect system shaped and dimensioned to allow a quick and easy fluidtight connection of the residue discharge duct to at least one of the pyrolysis reactor and the byproduct residue discharge line via at least one of the reactor-connecting end portion and the byproduct residue-recovering end portion.

7. The pyrolysis residue-discharge system according to claim 5, wherein at least one of the reactor-connecting end portion and the byproduct residue-recovering end portion comprises a sealing member to provide a fluidtight connection of the pyrolysis residue-discharge system respectively to the pyrolysis reactor and the byproduct residue discharge line.

8. The pyrolysis residue-discharge system according to claim 1, further comprising a byproduct residue collecting duct arrangeable in the fuel-containing cavity of the pyrolysis reactor and defining a byproduct residue-collecting channel, the byproduct residue collecting duct being fluid-tightly connectable to the reactor-connecting end portion to fluidly connect the byproduct residue-collecting channel and the residue discharge passageway.

9. The pyrolysis residue discharge system according to claim 1, wherein the pyrolysis residue-discharge system is fluid-tightly connectable to a pyrolysis oven at least partially containing the pyrolysis reactor and having a drainage opening formed therethrough, the residue discharge passageway being fluidly connectable with the drainage opening.

10. The pyrolysis residue-discharge system according to claim 9, wherein the pyrolysis residue-discharge system is fluid-tightly securable to a peripheral edge surrounding the drainage opening.

11. A pyrolysis reactor assembly comprising:
a pyrolysis reactor at least partially delimiting a fuel-containing cavity and having a discharge opening extending therethrough to provide access to the fuel-containing cavity; and
a pyrolysis residue discharge system comprising a residue discharge duct defining a residue discharge passageway having an inlet port and an outlet port, the residue discharge duct being fluid-tightly connected to the pyrolysis reactor at the inlet port thereof to provide a fluid communication between the fuel-containing cavity of the pyrolysis reactor and the residue discharge passageway via the discharge opening.

12. The pyrolysis reactor assembly according to claim 11, wherein the pyrolysis residue discharge system further comprises a reactor-connecting end portion having a through opening, the reactor-connecting end portion being fluid-tightly connected to the pyrolysis reactor to fluidly connect the through opening of the reactor-connecting end portion with the discharge opening of the pyrolysis reactor, the reactor-connecting end portion being fluid-tightly connected to the residue discharge duct at the inlet port thereof or being formed integral with the residue discharge duct and at least partially delimiting the inlet port thereof.

13. The pyrolysis reactor assembly according to claim 12, wherein the pyrolysis reactor comprises a peripheral wall at least partially delimiting the fuel-containing cavity, the discharge opening extending through the peripheral wall, wherein the reactor-connecting end portion is removably fluid-tightly securable to a peripheral edge surrounding the discharge opening of the pyrolysis reactor.

14. The pyrolysis reactor assembly according to claim 12, wherein the pyrolysis reactor further comprises a byproduct residue-collecting member arranged in the fuel-containing cavity, the byproduct residue-collecting member defining a byproduct residue-collecting cavity opening into the fuel-containing cavity, the residue discharge passageway being in fluid communication with the byproduct residue-collecting cavity.

15. The pyrolysis reactor assembly according to claim 14, wherein the pyrolysis reactor comprises a bottom wall at least partially delimiting the fuel-containing cavity, wherein the byproduct residue-collecting member extends upwardly from an inner surface of the bottom wall, substantially centrally thereof.

16. The pyrolysis reactor assembly according to claim 14, wherein the pyrolysis residue discharge system further comprises a byproduct residue collecting duct arranged in the fuel-containing cavity of the pyrolysis reactor and defining a byproduct residue-collecting channel in fluid communication with the byproduct residue-collecting cavity, the byproduct residue collecting duct being fluid-tightly connected to the reactor-connecting end portion to fluidly connect the byproduct residue-collecting cavity and the residue discharge passageway.

17. A pyrolysis system comprising:
a pyrolysis reactor assembly according to claim 11, and
a pyrolysis oven at least partially delimiting a reactor-receiving cavity and having a drainage opening extending therethrough, the pyrolysis reactor being at least partially contained in the reactor-receiving cavity;
wherein the pyrolysis residue-discharge system is fluid-tightly connected to the pyrolysis oven, the residue discharge passageway being fluidly connected with the drainage opening.

18. The pyrolysis system according to claim 17, wherein the pyrolysis oven comprises a wall portion delimiting at least partially the reactor-receiving cavity, the drainage opening extending through the wall portion and being substantially aligned with the discharge opening of the pyrolysis reactor.

19. A method for discharging pyrolysis residues generated upon pyrolysis of a fuel, the method comprising:
providing a pyrolysis reactor at least partially delimiting a fuel-containing cavity and having a discharge opening extending therethrough;
feeding the fuel-containing cavity with the fuel;
inserting the pyrolysis reactor into a reactor-receiving cavity of a pyrolysis oven, the pyrolysis oven having a drainage opening extending therethrough;
providing a pyrolysis byproduct residue discharge system comprising a residue discharge duct defining a residue discharge passageway having an inlet port and an outlet port;
fluid-tightly connecting the residue discharge duct to the pyrolysis reactor at the inlet port thereof, with the inlet port being in fluid communication with the discharge opening of the pyrolysis reactor; and
fluid-tightly connecting the residue discharge duct to the pyrolysis oven at the outlet port thereof, with the outlet port being in fluid communication with the drainage opening of the pyrolysis oven and opening into an oven exterior;
wherein the pyrolysis residues generated in the fuel-containing cavity upon pyrolysis of the fuel are discharged outwardly of the fuel-containing cavity and the reactor-receiving cavity via the residue discharge passageway of the pyrolysis byproduct residue discharge system.

20. The method according to claim 19, further comprising fluid-tightly connecting a byproduct residue-recovering end portion of the pyrolysis byproduct residue discharge system to a residue discharge line, the byproduct residue-recovering end portion being fluid-tightly connected to the residue discharge duct at the outlet port thereof or being formed integral with the residue discharge duct and at least partially delimiting the outlet port thereof.
